(19) United States
(12) Patent Application Publication
(10) Pub. No.: US 2026/0038158 A1
(43) Pub. Date: Feb. 5, 2026

(54) MESH DECODING DEVICE, MESH DECODING METHOD, AND PROGRAM

(71) Applicant: KDDI CORPORATION, Tokyo (JP)

(72) Inventors: Kouki KISHIMOTO, Fujimino-shi (JP); Kei KAWAMURA, Fujimino-shi (JP)

(73) Assignee: KDDI CORPORATION, Tokyo (JP)

(21) Appl. No.: 19/351,439

(22) Filed: Oct. 7, 2025

Related U.S. Application Data
(63) Continuation of application No. PCT/JP2024/007919, filed on Mar. 3, 2024.

(30) Foreign Application Priority Data
Apr. 14, 2023 (JP) 2023-066598

(51) Int. Cl. G06T 9/00

(52) U.S. Cl. CPC G06T 9/001

(57) ABSTRACT

A mesh decoding device (200) according to the present invention includes: a subdivision unit (203) configured to generate and output a subdivision mesh and a subdivision vertex normal based on a base sub-mesh; and a mesh decoding unit (204) configured to generate and output, when two different displacements exist for a same vertex on a sub-mesh boundary, a decoded mesh by using the two different displacements having been corrected.

### CROSS-REFERENCE TO RELATED APPLICATIONS

The present application is a continuation of PCT Application No. PCT/JP2024/007919, filed on Mar. 3, 2024, which claims the benefit of Japanese patent application No. 2023-066598 filed on Apr. 14, 2023; the entire contents of each application being incorporated herein by reference in its entirety.

### TECHNICAL FIELD

The present invention relates to a mesh decoding device, a mesh decoding method, and a program.

### BACKGROUND ART

In Reference 1 (Khaled Mammou, Jungsun Kim, Alexis Tourapis, Dimitri Podborski, Krasimir Kolarov, “[V-CG] Apple's Dynamic Mesh Coding CfP Response,” ISO/IEC JTC 1/SC 29/WG 7 m5928, April 2022), a mesh is decoded by being divided into a base mesh representing rough information and a displacement representing detailed information, and such a displacement is decoded by a video codec.

### SUMMARY OF THE INVENTION

However, Reference 1 has a problem that, in a case where the processing is changed in units of sub-meshes and patches, holes are formed at a boundary portion of a sub-mesh or a patch, and subjective performance may be deteriorated. Therefore, the present invention has been made in view of the above-described problems, and an object of the present invention is to provide a mesh decoding device, a mesh decoding method, and a program capable of decoding continuous mesh data by correcting a displacement defined for a vertex on a boundary of a sub-mesh or a patch.

A first feature of the present invention is summarized as a mesh decoding device including: a subdivision unit configured to generate and output a subdivision mesh and a subdivision vertex normal based on a base sub-mesh; and a mesh decoding unit configured to generate and output, when two different displacements exist for a same vertex on a sub-mesh boundary, a decoded mesh by using the two different displacements having been corrected.

A second feature of the present invention is summarized as a mesh decoding method including: generating and outputting a subdivision mesh and a subdivision vertex normal based on a base sub-mesh; and when two different displacements exist for a same vertex on a sub-mesh boundary, generating and outputting a decoded mesh by using the two different displacements having been corrected.

A third feature of the present invention is summarized as a program for causing a computer to function as a mesh decoding device, wherein the mesh decoding device includes: a subdivision unit configured to generate and output a subdivision mesh and a subdivision vertex normal based on a base sub-mesh, and a mesh decoding unit configured to generate and output, when two different displacements exist for a same vertex on a sub-mesh boundary, a decoded mesh by using the two different displacements having been corrected.

According to the present invention, it is possible to provide a mesh decoding device, a mesh decoding method, and a program capable of decoding continuous mesh data by correcting a displacement defined for a vertex on a boundary of a sub-mesh or a patch.

### BRIEF DESCRIPTION OF THE DRAWINGS

FIG. 1 is a diagram illustrating an example of a configuration of a mesh processing system 1 according to an embodiment.

FIG. 2 is a diagram illustrating an example of functional blocks of a mesh decoding device 200 according to an embodiment.

FIG. 3 is a diagram illustrating an example of functional blocks of an atlas data decoding unit 207 of the mesh decoding device 200 according to an embodiment.

FIG. 4 is a diagram illustrating an example of functional blocks of a patch information decoding unit 207B of the atlas data decoding unit 207 of the mesh decoding device 200 according to an embodiment.

FIG. 5 is a diagram illustrating an example of functional blocks of a patch control information decoding unit 207C of the atlas data decoding unit 207 of the mesh decoding device 200 according to an embodiment.

FIG. 6 is a diagram illustrating an example of functional blocks of a subdivision unit 203 of the mesh decoding device 200 according to an embodiment.

FIG. 7 is a flowchart describing an example of an operation of the subdivision vertex normal calculation unit 203C.

FIG. 8A is a diagram for describing an example of a method of calculating a subdivision vertex normal by the subdivision vertex normal calculation unit 203C.

FIG. 8B is a diagram for describing an example of the method of calculating the subdivision vertex normal by the subdivision vertex normal calculation unit 203C.

FIG. 9 is a diagram illustrating an example of functional blocks of a displacement decoding unit 205 of the mesh decoding device 200 according to an embodiment.

FIG. 10 is a diagram illustrating an example of a correspondence table of a control signal and a displacement encoding method used in the displacement decoding unit 205 of the mesh decoding device 200 according to an embodiment.

FIG. 11 is a flowchart illustrating an example of an operation of an inverse quantization unit 205D of the displacement decoding unit 205 of the mesh decoding device 200 according to an embodiment.

FIG. 12 is a flowchart illustrating an example of an operation of a mesh decoding unit 204 of the mesh decoding device 200 according to an embodiment.

### DESCRIPTION OF EMBODIMENTS

Hereinafter, embodiments of the present invention will be described with reference to the drawings. Note that components in the following embodiments can be replaced with existing components or the like as appropriate, and various variations including combinations with other existing components are possible. Therefore, the following description of the embodiments does not limit the contents of the invention described in the claims.

### First Embodiment

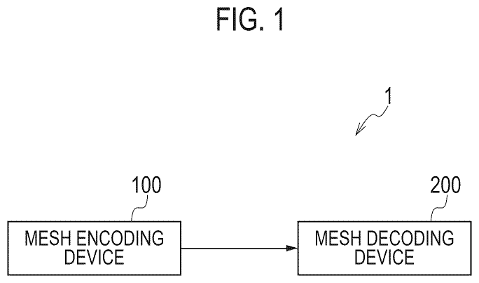

Hereinafter, a mesh processing system 1 according to the present embodiment will be described with reference to FIGS. 1 to 12.

FIG. 1 is a diagram illustrating an example of a configuration of the mesh processing system 1 according to the present embodiment. As illustrated in FIG. 1, the mesh processing system 1 includes a mesh encoding device 100 and a mesh decoding device 200.

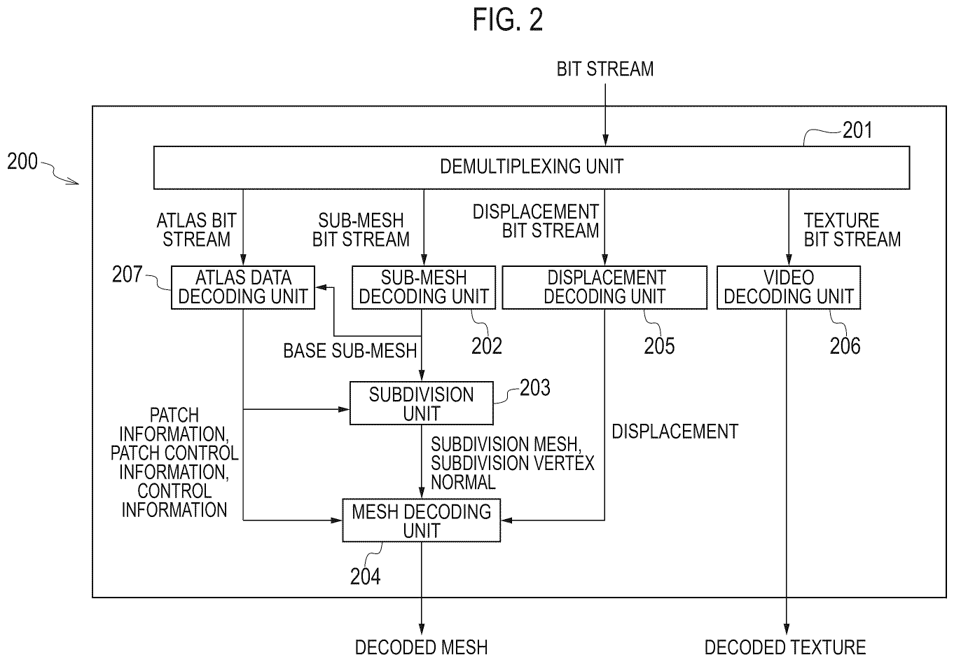

FIG. 2 is a diagram illustrating an example of functional blocks of the mesh decoding device 200 according to the present embodiment.

As illustrated in FIG. 2, the mesh decoding device 200 includes a demultiplexing unit 201, a sub-mesh decoding unit 202, a subdivision unit 203, a mesh decoding unit 204, a displacement decoding unit 205, a video decoding unit 206, and an atlas data decoding unit 207.

The demultiplexing unit 201 is configured to separate a multiplexed bit stream into an atlas bit stream, a sub-mesh bit stream, a displacement bit stream, a texture bit stream, and an atlas bit stream.

The sub-mesh decoding unit 202 is configured to decode the sub-mesh bit stream, and generate and output a base sub-mesh.

The subdivision unit 203 is configured to generate and output added subdivision vertices and connection information thereof from the base sub-mesh decoded by the sub-mesh decoding unit 202 by a subdivision method indicated by patch control information.

Here, the base sub-mesh, the added subdivision vertex, and the connection information thereof are collectively referred to as a “subdivision mesh”.

The sub-mesh is a part of mesh data that can be decoded alone, and one sub-mesh includes several patches. The patch is metadata, and is a set of patch information indicating a partial region of the sub-mesh and various types of control information related to the patch.

The mesh decoding unit 204 is configured to generate and output a decoded mesh by using the subdivision mesh generated by the subdivision unit 203 and the displacement decoded by the displacement decoding unit 205.

The displacement decoding unit 205 is configured to decode a displacement bit stream to generate and output a displacement.

The video decoding unit 206 is configured to decode and output texture by video codec. For example, the video decoding unit 206 may use HEVC disclosed in Reference Literature 1 “Information technology—High efficiency coding and media delivery in heterogeneous environments—Part 2: High efficiency video coding, ISO/IEC 23008-2:2013”.

The atlas data decoding unit 207 is configured to decode the atlas bit stream to output the patch information, the patch control information, and the control information.

### (Atlas Data Decoding Unit 207)

The atlas data decoding unit 207 is configured to decode the atlas bit stream to output the patch information, the patch control information, and the control information.

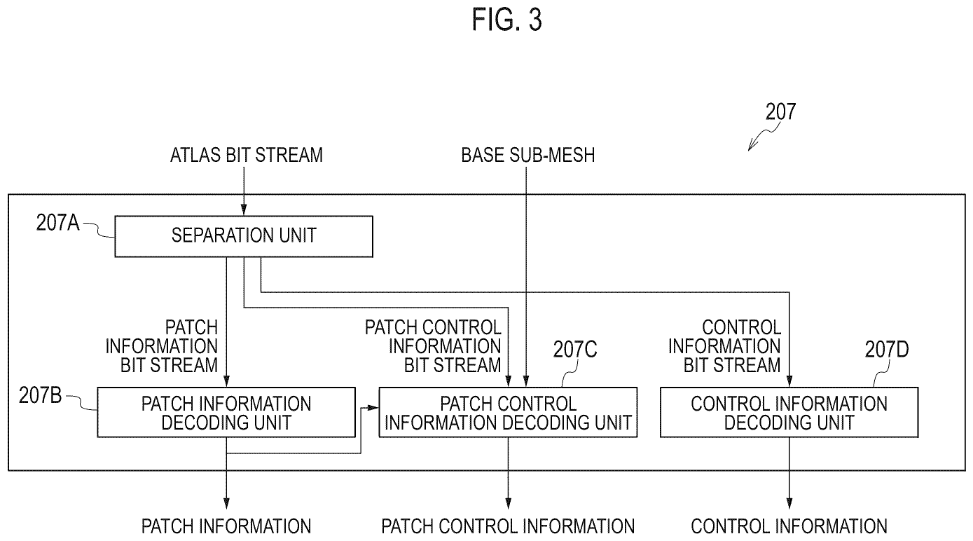

FIG. 3 is a diagram illustrating an example of functional blocks of the atlas data decoding unit 207.

As illustrated in FIG. 3, the atlas data decoding unit 207 includes a separation unit 207A, a patch information decoding unit 207B, a patch control information decoding unit 207C, and a control information decoding unit 207D.

The separation unit 207A separates the input atlas bit stream into a patch information bit stream, a patch control information bit stream, and a control information bit stream, and outputs the patch information bit stream, the patch control information bit stream, and the control information bit stream.

### (Patch Information Decoding Unit 207B)

The patch information decoding unit 207B is configured to calculate and output patch information on the basis of the input patch information bit stream.

Here, the patch information is information indicating to which patch a base face existing in the sub-mesh belongs.

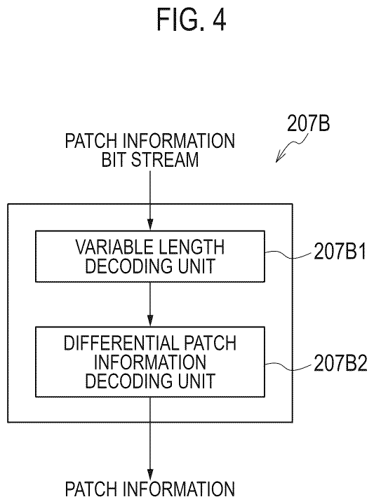

FIG. 4 is a diagram illustrating an example of functional blocks of the patch information decoding unit 207B.

As illustrated in FIG. 4, the patch information decoding unit 207B includes a variable length decoding unit 207B1 and a differential patch information decoding unit 207B2.

Hereinafter, a specific patch information decoding method will be described.

The variable length decoding unit 207B1 is configured to calculate differential patch information from the input patch information bit stream by using an exponential Golomb coding algorithm and output the differential patch information.

The variable length decoding unit 207B1 may be configured to output a one-dimensional vector representing a patch number for every base face.

For example, in a case where, as for the base faces 1, 2, 3, 4, and 5, the base faces 1 to 3 belong to the patch 0 and the base faces 4 and 5 belong to the patch 1, the one-dimensional vector can be expressed as [0, 0, 0, 1, 1].

The variable length decoding unit 207B1 may output index numbers of all the faces included in each patch, or may be configured to directly output a first index and a last index included in each patch.

At this time, the variable length decoding unit 207B1 may calculate the differential patch information by using an existing integer coding method such as arithmetic coding or run length encoding.

The differential patch information decoding unit 207B2 is configured to calculate and output patch information on the basis of the input differential patch information.

The differential patch information includes a first differential index s′ and a last differential index e′.

Here, in the differential patch information, the j-th first differential index of the patch i is s′ [i][j], and the last differential index is e′ [i][j].

The patch information includes a first index s and a last index e.

Here, in the patch information, similarly to the differential patch information, the j-th first index of the patch i is s[i][j], and the last index is e[i][j].

The first index and the last index represent the number of faces included in each patch.

For example, s[0][0]=1, e[0][0]=4, s[0][1]=7, e[0][1]=8 indicates that the faces 1 to 4 and the faces 7 to 8 are included in the patch 0.

When j=0, the first index s[i][j] and the last index e[i][j] are calculated as follows.

$$s [ i ] [ 0 ] = {s}^{′} [ i ] [ 0 ]$$

$$e [ i ] [ 0 ] = {e}^{′} [ i ] [ 0 ] + s [ i ] [ 0 ]$$

When j>0, the first index s[i][j] and the last index e[i][j] are calculated as follows.

$$s [ i ] [ j ] = {s}^{′} [ i ] [ j ] + e [ i ] [ j - 1 ] + 2$$

$$e [ i ] [ j ] = {e}^{′} [ i ] [ j ] + s [ i ] [ j ]$$

When the patch information has already been calculated by the variable length decoding unit 207B1, the differential patch information decoding unit 207B2 may directly output the input information as the patch information without performing the processing described above.

### (Patch Control Information Decoding Unit 207C)

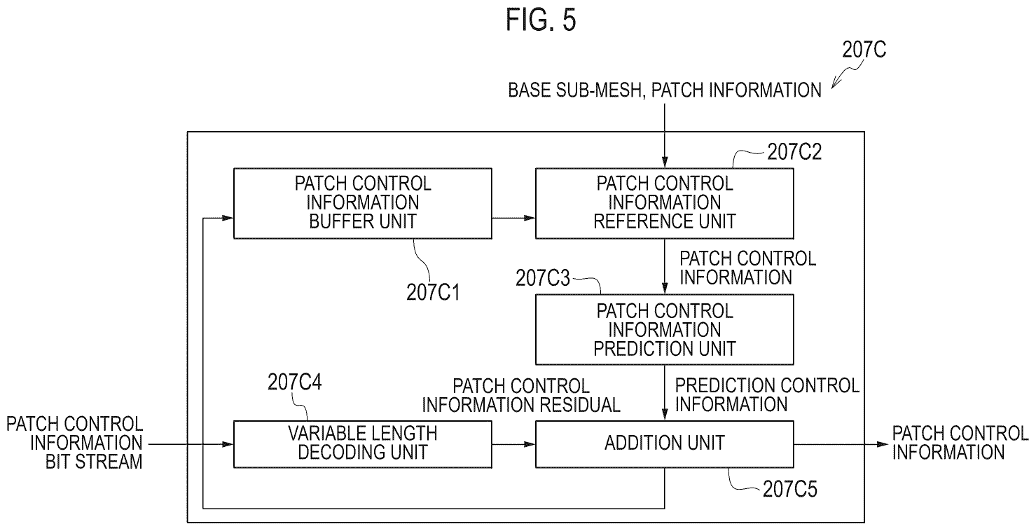

FIG. 5 is a diagram illustrating an example of functional blocks of the patch control information decoding unit 207C.

As illustrated in FIG. 5, the patch information decoding unit 207C includes a patch control information buffer unit 207C1, a patch control information reference unit 207C2, a patch control information prediction unit 207C3, a variable length decoding unit 207C4, and an addition unit 207C5.

The patch information decoding unit 207C is configured to calculate and output the patch control information on the basis of the input patch information, the base sub-mesh, and parameter control information residual.

The patch control information is control information other than the patch information defined for every patch. For example, the patch control information includes the number of subdivisions, a method of calculating a normal direction, and the like.

The patch control information buffer unit 207C1 stores patch control information for every patch, and is configured to output the patch control signal to the patch control information reference unit.

Specifically, the patch control information buffer unit 207C1 is configured to store the patch control information included in the patch control information bit stream.

Here, the size of the patch control information buffer unit 207C1 may be “1”, and the patch control information buffer unit 207C1 may be configured to output the previously accumulated patch control information to the patch control information reference unit 207C2.

In a case where the patch adjacent to a decoding target patch does not exist, or in a case where the patch adjacent to the decoding target patch exists but a parameter is not fixed, the patch control information reference unit 207C2 is configured to output “reference impossible” to the patch control information prediction unit 207C3.

Here, the information of the adjacent patch is calculated from the base sub-mesh and the patch information.

In a case where the patch adjacent to the decoding target patch exists and the patch control information is fixed, the patch control information reference unit 207C2 is configured to output the patch control information to the patch control information prediction unit 207C3.

The patch control information prediction unit 207C3 is configured to predict the patch control information of the decoding target patch on the basis of the input one or more parameters, and output the predicted patch control information (predicted control information) to the addition unit 207C5.

Here, in a case where only “reference impossible” is input from the patch control information reference unit 207C2, the patch control information prediction unit 207C3 is configured to output 0 to the addition unit 207C5.

Note that, in a case where one or more parameters are input, the patch control information prediction unit 207C3 may be configured to generate the predicted control information by using any one of statistical values such as an average value, a maximum value, a minimum value, or a mode value of the input parameters.

In a case where one or more pieces of patch control information are input, the patch control information prediction unit 207C3 may be configured to predict any patch information of the adjacent patch and generate the predicted patch information as the predicted control information.

The variable length decoding unit 207C4 is configured to calculate patch control information residual from the input patch control information bit stream by using an exponential Golomb coding algorithm and output the patch control information residual.

At this time, the variable length decoding unit 207C4 may calculate the patch control information residual by using an existing integer coding method such as arithmetic coding.

The addition unit 207C5 is configured to output patch control information obtained by adding the patch control information residual acquired from the variable length decoding unit 207C4 and the predicted control information acquired from the patch control information prediction unit 207C3.

### (Subdivision Unit 203)

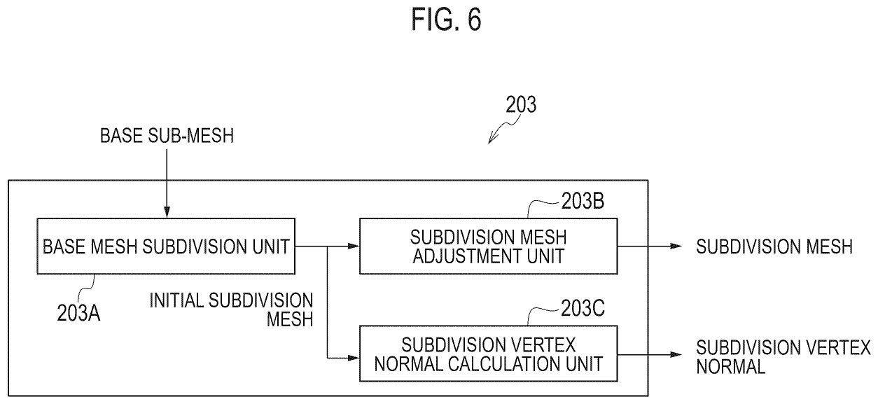

FIG. 6 is a diagram illustrating an example of functional blocks of the subdivision unit 203.

As illustrated in FIG. 6, the subdivision unit 203 includes a base mesh subdivision unit 203A, a subdivision mesh adjustment unit 203B, and a subdivision vertex normal calculation unit 203C.

The base mesh subdivision unit 203A is configured to output an initial subdivision mesh on the basis of the input base sub-mesh.

The subdivision mesh adjustment unit 203B is configured to adjust the initial subdivision mesh.

Here, the adjustment is an operation of generating the subdivision mesh in which no hole is formed in the mesh when the mesh is decoded by the mesh decoding unit 204.

### (Subdivision Vertex Normal Calculation Unit 203C)

The subdivision vertex normal calculation unit 203C is configured to output a normal (subdivision vertex normal) defined for each subdivision vertex for the subdivision vertex forming the input subdivision face.

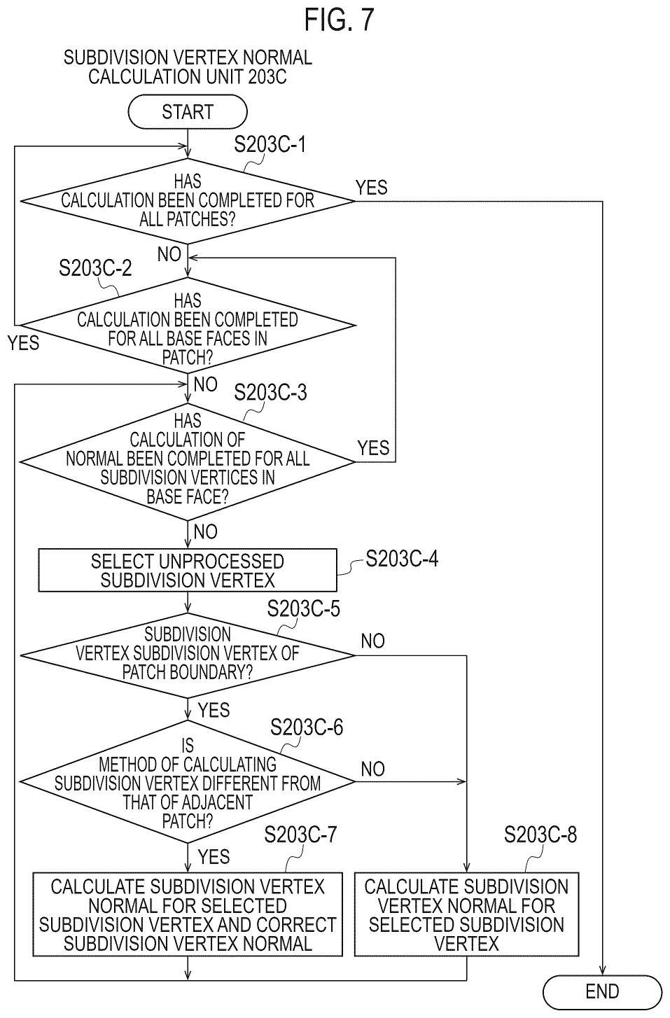

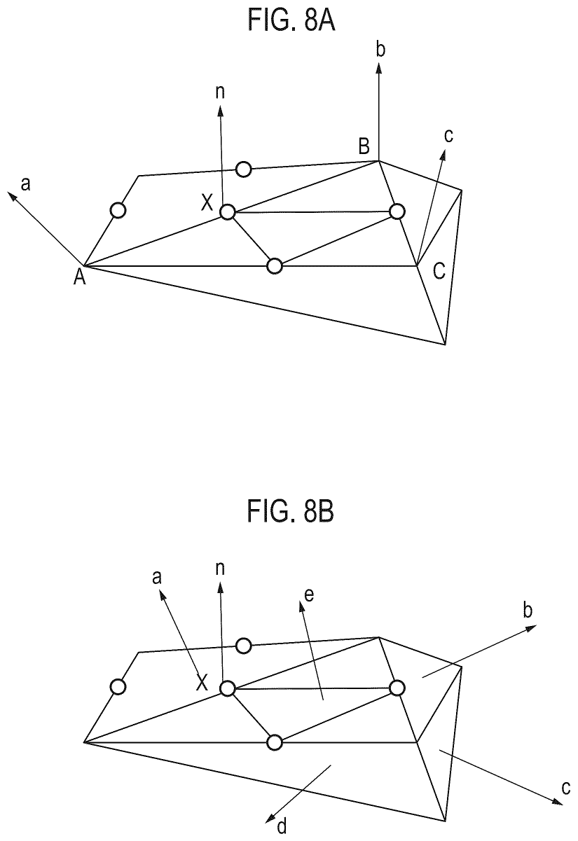

Hereinafter, an example of processing performed by the subdivision vertex normal calculation unit 203C will be described with reference to FIGS. 7 and 8.

FIG. 7 is a flowchart describing an example of an operation of the subdivision vertex normal calculation unit 203C.

As illustrated in FIG. 7, in step S203C-1, the subdivision vertex normal calculation unit 203C determines whether calculation processing of the subdivision vertex has been completed for all the patches.

In the case of Yes, the operation ends, and in the case of No, the operation proceeds to step S203C-2.

In step S203C-2, the subdivision vertex normal calculation unit 203C determines whether the calculation processing of the subdivision vertex normal has been completed for all the base faces in the patch.

In the case of Yes, the operation proceeds to step S203C-1, and in the case of No, the operation proceeds to step S203C-3.

In step S203C-3, the subdivision vertex normal calculation unit 203C determines whether the calculation processing of the subdivision vertex normal has been completed for all the subdivision vertices in the base face.

In the case of Yes, the operation proceeds to step S203C-2, and in the case of No, the operation proceeds to step S203C-4.

In step S203C-4, the subdivision vertex normal calculation unit 203C selects an unprocessed subdivision vertex, and the operation proceeds to step S203C-5.

In step S203C-5, the subdivision vertex normal calculation unit 203C determines whether the selected subdivision vertex is a subdivision vertex of a patch boundary.

In the case of Yes, the operation proceeds to step S203C-6, and in the case of No, the operation proceeds to step S203C-8.

In step S203C-6, the subdivision vertex normal calculation unit 203C determines whether a method of calculating the subdivision vertex is different from that of the adjacent patch.

In the case of Yes, the operation proceeds to step S203C-7, and in the case of No, the operation proceeds to step S203C-8.

In step S203C-7, the subdivision vertex normal calculation unit 203C calculates a subdivision vertex normal for the selected subdivision vertex, and corrects the subdivision vertex normal.

Hereinafter, the method of calculating the subdivision vertex normal will be described.

First, the subdivision vertex normal calculation unit 203C calculates the subdivision vertex normal for the selected subdivision vertex normal on the basis of a control signal that specifies a type of the method of calculating the subdivision vertex normal specified by the decoding target patch.

FIGS. 8A and 8B illustrate that a subdivision vertex normal is calculated for a subdivision vertex X in a base face ABC in step S203C-7.

The method of calculating the subdivision vertex normal will be described with reference to FIG. 8A.

The subdivision vertex normal calculation unit 203C may be configured to calculate a normal n (vector) of the subdivision vertex X on the base face ABC based on the total value of base point normals as expressed in the following (Expression 1).

$$[ Expression 1 ]$$

$$n = ( a + b + c ) / ( ‖ a + b + c ‖ ) , \qquad Expression 1$$

At this time, a, b, and c (vectors) are normals (base point normals) defined for each base point (a vertex forming the base face).

Furthermore, another example of the method of calculating the subdivision vertex normal will be described with reference to FIG. 8B.

The subdivision vertex normal calculation unit 203C may be configured to calculate the normal n (vector) of the subdivision vertex X on the base face ABC based on the total value of normals of base faces adjacent to the base face ABC as expressed in the following (Expression 2).

$$[ Expression 2 ]$$

$$n = ( a + b + c + d + e ) / ( ‖ a + b + c + d + e ‖ ) \qquad ( Expression 2 )$$

At this time, a, b, c, d, and e (vectors) are face normals (vectors) of the base faces adjacent to the base face ABC.

In addition, the subdivision vertex normal calculation unit 203C may simply use the face normal of the base face ABC as the normal (subdivision point normal) of the subdivision vertex X.

With such calculation, basically, the same normal is used as the normal of the subdivision point normal existing on the same base face.

In addition, the subdivision vertex normal calculation unit 203C may similarly calculate the base point normal by using the above-described method of calculating the subdivision vertex normal.

At this time, basically, the same normal is used as the subdivision point normal and the base point normal existing on the same base face.

Second, the subdivision vertex normal calculation unit 203C calculates the subdivision vertex normal for the selected subdivision vertex normal on the basis of a control signal that specifies a type of the method of calculating the subdivision vertex normal specified by the adjacent patch.

The method of calculating the base point normal and the subdivision vertex normal is similar to the above.

Hereinafter, a method of correcting the subdivision vertex normal will be described.

The subdivision vertex normal calculation unit 203C corrects the subdivision vertex normal by using either one of the obtained two subdivision vertex normals.

The subdivision vertex normal calculation unit 203C may correct the subdivision vertex normal by using the average value of the obtained two subdivision vertex normals.

In step S203-C8, the subdivision vertex normal calculation unit 203C calculates a subdivision vertex normal of the selected subdivision vertex, and the operation proceeds to step S203C-3.

The method of calculating the normal of the subdivision vertex is as described above.

### (Displacement Decoding Unit 205)

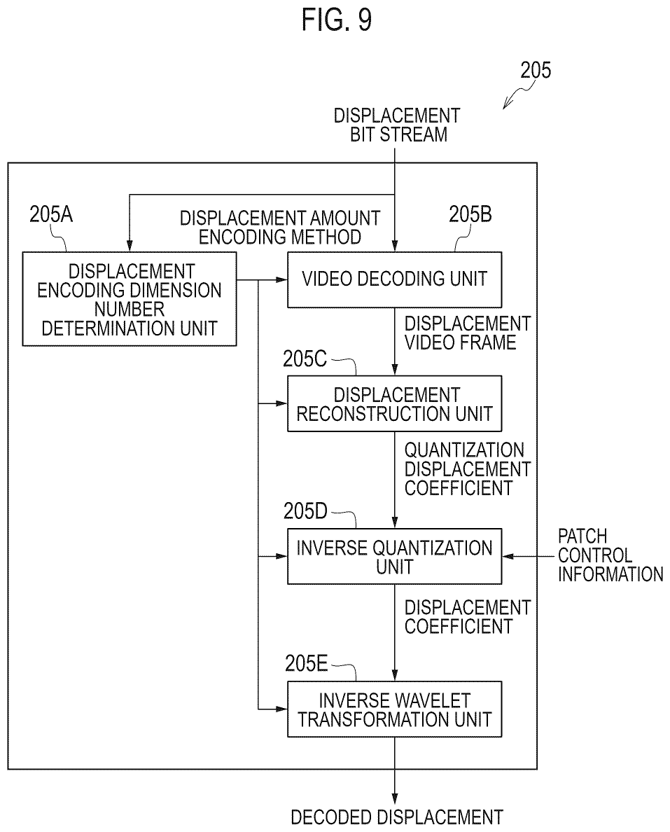

As illustrated in FIG. 9, displacement decoding unit 205 includes a displacement encoding dimension number determination unit 205A, a video decoding unit 205B, a displacement reconstruction unit 205C, an inverse quantization unit 205D, and an inverse wavelet transform unit 205E.

The displacement encoding dimension number determination unit 205A is configured to determine and output a displacement encoding method indicating a displacement encoding method (decoding method) by using control information defined in the displacement bit stream.

Here, the displacement encoding dimension number determination unit 205A is configured to determine and output a displacement decoding method on the basis of the value of control information chroma_format_idc indicating a YUV format and the value of control information neutral_chroma_indication_flag indicating that all Chroma samples are decoded with the same value.

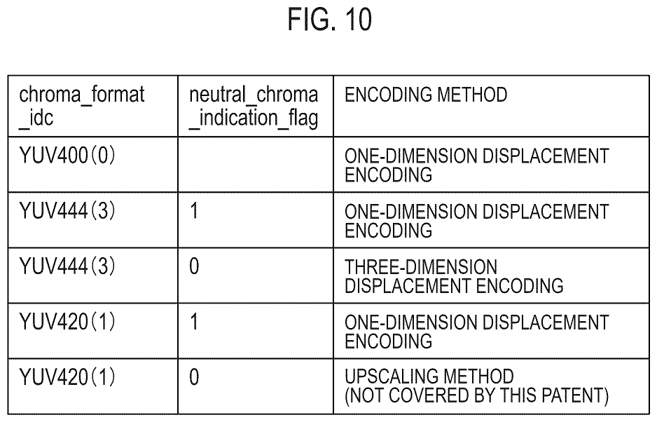

FIG. 10 illustrates an example of a correspondence table between the control signal and a displacement encoding method.

The video decoding unit 205B is configured to output a displacement video frame by decoding the displacement bit stream by using an existing video codec technology on the basis of the input displacement bit stream and displacement encoding method.

The displacement reconstruction unit 205C is configured to extract and output a displacement from the input displacement video frame.

Here, when the above-described displacement encoding method is one-dimensional displacement encoding, displacement reconstruction unit 205C may be configured not to perform the processing on a channel of the displacement video frame corresponding to a component orthogonal to the normal direction, but to perform the processing only on a channel corresponding to the normal direction.

### (Inverse Quantization Unit 205D)

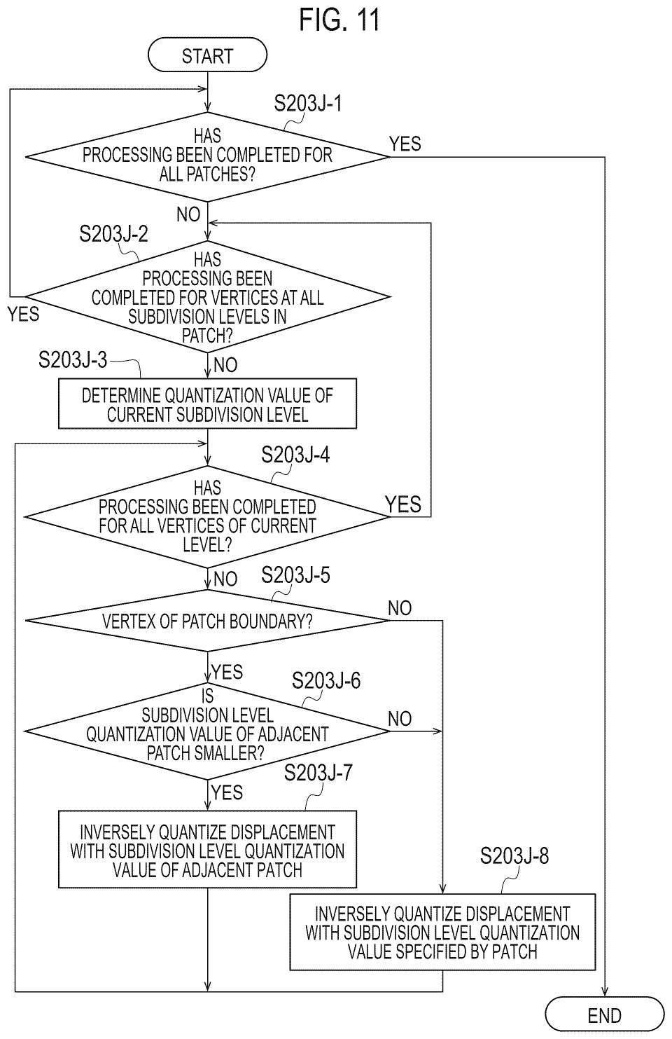

FIG. 11 is a flowchart illustrating an example of an operation of the inverse quantization unit 205D.

As illustrated in FIG. 11, in step S203J-1, the inverse quantization unit 205D determines whether the processing has been completed for all the patches.

In the case of Yes, the operation ends the processing, and in the case of No, the operation proceeds to step S203J-2.

In step S203J-2, the inverse quantization unit 205D determines whether the processing has been completed for the vertices at all subdivision levels in the patch.

Here, the subdivision level represents the number of times of subdivision, and when the subdivision level is 0, the subdivision level represents a base point.

In the case of Yes, the operation proceeds to step S203J-1, and in the case of No, the operation proceeds to step S203J-3.

In step S203J-3, the inverse quantization unit 205D determines a quantization value of the current subdivision level on the basis of the patch control information, and the operation proceeds to step S203J-4.

In step S203J-4, the inverse quantization unit 205D determines whether the inverse quantization processing has been completed for all the displacements of the current subdivision level.

In the case of Yes, the operation proceeds to step S203J-2, and in the case of No, the operation proceeds to step S203J-5.

In step S203J-5, the inverse quantization unit 205D determines whether the vertex is a vertex of the patch boundary.

In the case of Yes, the operation proceeds to step S203J-6, and in the case of No, the operation proceeds to step S203J-8.

In step S203J-6, the inverse quantization unit 205D determines whether a subdivision level quantization value of the adjacent patch is smaller than that of the current patch.

In the case of Yes, the operation proceeds to step S203J-7, and in the case of No, the operation proceeds to step S203J-8.

In step S203J-7, the inverse quantization unit 205D inversely quantizes the displacement with the subdivision level quantization value of the adjacent patch.

The inverse quantization unit 205D may be configured to skip the inverse quantization processing on two displacement components orthogonal to the normal direction and perform the inverse quantization processing only on the displacement component in the normal direction when the above-described displacement encoding method is one-dimensional displacement encoding.

At this time, the inverse quantization unit 205D may perform the inverse quantization by using uniform quantization in Reference Literature 2 “Jinhua Yu, “Advantages of uniform scalar dead-zone quantization in image coding system” in 2004 International Conference on Communications, Circuits and Systems (IEEE Cat. No. 04EX914). IEEE, 2004, vol. 2, pp. 805-808”, or may perform the inverse quantization by using another known inverse quantization method.

In step 203J-8, the inverse quantization unit 205D inversely quantizes the displacement with the subdivision level quantization value calculated in step S203J-3. Here, the method of inverse quantization is similar to step S203J-7.

When the selected vertex is a sub-mesh boundary, the inverse quantization unit 205D may perform decoding with the displacement set to 0.

The inverse wavelet transform unit 205E is configured to perform inverse wavelet transform on a displacement coefficient output by the inverse quantization unit 205D and output a decoded displacement.

The inverse wavelet transform unit 205E may be configured to skip inverse wavelet transform processing on two displacement components orthogonal to the normal direction and perform the inverse wavelet transform only on the displacement component in the normal direction.

The inverse wavelet transform unit 205E may be configured to output a displacement having only a normal direction component.

### (Mesh Decoding Unit 204)

The mesh decoding unit 204 is configured to output the decoded mesh on the basis of the input patch information, the subdivision mesh, and the displacement.

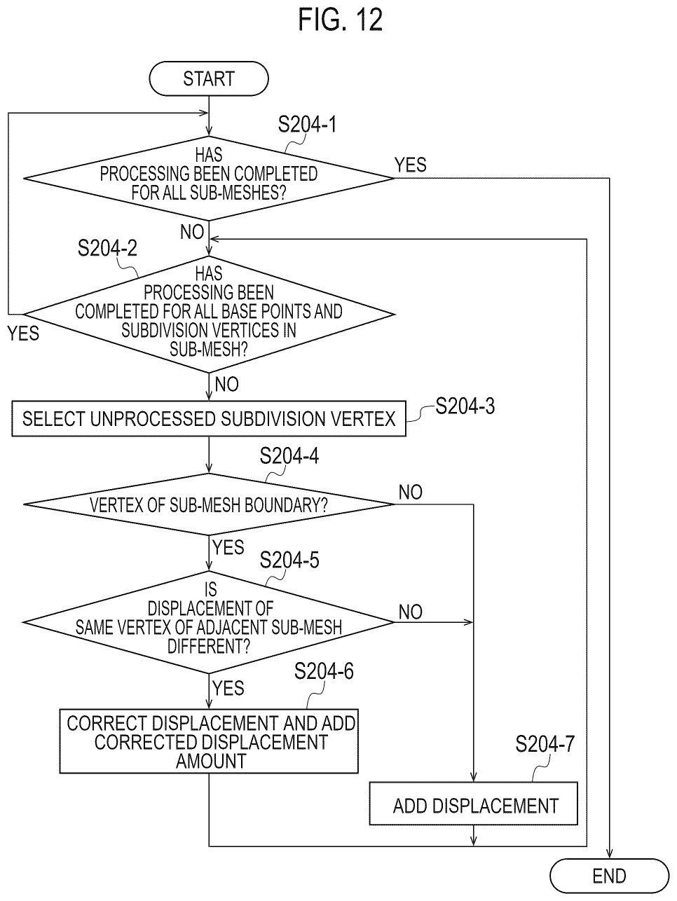

FIG. 12 is a flowchart illustrating an example of an operation of the mesh decoding unit 204.

As illustrated in FIG. 12, in step S204-1, the mesh decoding unit 204 determines whether the processing has been completed for all the sub-meshes.

In the case of Yes, the operation ends the processing, and in the case of No, the operation proceeds to step S204-2.

In step S204-2, the mesh decoding unit 204 determines whether the processing has been completed for all the subdivision vertices in the sub-mesh.

In the case of Yes, the operation proceeds to step S204-3, and in the case of No, the operation proceeds to step S204-1.

In step S204-3, the mesh decoding unit 204 selects a vertex in the sub-mesh, and the operation proceeds to step S204-4.

In step S204-4, the mesh decoding unit 204 determines whether the vertex is a vertex of a sub-mesh boundary.

In the case of Yes, the operation proceeds to step S204-5, and in the case of No, the operation proceeds to step S204-7.

In step S204-5, the mesh decoding unit 204 determines whether the displacement of the selected vertex is different from the displacement of the same vertex of the adjacent sub-mesh.

Here, when the distance between the vertices is equal to or less than a threshold value, the mesh decoding unit 204 determines that the vertices are the same.

In a case where the vertex information of the sub-mesh boundary adjacent to any of the patch information, the patch control information, or the control information is given, the mesh decoding unit 204 may determine the same vertex on the basis of vertex information of the sub-mesh boundary.

In the case of Yes, the operation proceeds to step S204-6, and in the case of No, the operation proceeds to step S204-7.

In step S204-6, the mesh decoding unit 204 corrects the displacement at the selected subdivision vertex, and adds the corrected displacement to the subdivision vertex.

The mesh decoding unit 204 may correct the displacement by using an average value of two different displacements, or may correct the displacement by using one of the two different displacements.

In step S204-7, the mesh decoding unit 204 adds the displacement to the subdivision vertex, and the operation proceeds to step S204-2.

The mesh decoding unit 204 may obtain the same vertex between the sub-meshes by a similar procedure to the above, and correct the same vertex after addition of the displacement. As described above, the correction may be performed as an average value of the same vertex coordinates, or may be performed by using any of the same vertex coordinates.

In the present embodiment, encoding can be performed efficiently by encoding an index of the base face included in the patch as a difference between the first index and the last index.

In the present embodiment, it is possible to decode continuous mesh data by correcting a displacement defined for a vertex on a boundary of a sub-mesh or a patch.

Furthermore, in the present embodiment, the displacement can be efficiently compressed by encoding only a normal direction component of the displacement.

The mesh encoding device 100 and the mesh decoding device 200 described above may be implemented as programs that cause a computer to execute each function (each step).

Note that, according to the present embodiment, for example, comprehensive improvement in service quality can be realized in moving image communication, and thus, it is possible to contribute to goal 9 “Establish a resilient infrastructure, promote sustainable industrialization, and expand innovation” of the sustainable development goals (SDGs) led by the United Nations.

What is claimed is:

1. A mesh decoding device comprising a circuit, wherein
the circuit:
generates and outputs a subdivision mesh and a subdivision vertex normal based on a base sub-mesh; and
generates and outputs, when two different displacements exist for the same vertex on a sub-mesh boundary, a decoded mesh by using the two different displacements having been corrected.

2. The mesh decoding device according to claim 1, wherein
the circuit corrects the subdivision vertex normal by using either an average value of two normals calculated after obtaining the subdivision vertex normal by two different methods or one of the two normals when methods of calculating the subdivision vertex normal of a decoding target patch of an adjacent patch are different.

3. The mesh decoding device according to claim 1, wherein
when a distance between two vertices existing in different sub-meshes is equal to or less than a threshold value, the circuit determines that the two vertices are the same vertex.

4. The mesh decoding device according to claim 1, wherein
when two different displacements exist for the same vertex on the sub-mesh boundary, the circuit corrects the two different displacements by using either an average value of the two different displacements or one of the two different displacements.

5. A mesh decoding method comprising:
generating and outputting a subdivision mesh and a subdivision vertex normal based on a base sub-mesh; and
when two different displacements exist for the same vertex on a sub-mesh boundary, generating and outputting a decoded mesh by using the two different displacements having been corrected.

6. A program stored on a non-transitory computer-readable medium for causing a computer to function as a mesh decoding device, wherein
the mesh decoding device includes a circuit, and the circuit:
generates and outputs a subdivision mesh and a subdivision vertex normal based on a base sub-mesh, and
generates and outputs, when two different displacements exist for the same vertex on a sub-mesh boundary, a decoded mesh by using the two different displacements having been corrected.
